(19) United States
(12) Patent Application Publication
(10) Pub. No.: US 2026/0203735 A1
(43) Pub. Date: Jul. 16, 2026

(54) RAPID VALUE TRANSFER BETWEEN DIFFERENT VALUE SYSTEMS

(71) Applicant: Visa International Service Association, San Francisco, CA (US)

(72) Inventors: Joshua Moss, New York, NY (US); Luis Reina Javier, San Francisco, CA (US); Zaid Kanaan, San Francisco, CA (US); Robert Roche, Tarrytown, NY (US); Nolan Crawford, NewYork, NY (US); Bryce Jurss, Austin, TX (US)

(73) Assignee: Visa International Service Association, San Francisco, CA (US)

(21) Appl. No.: 19/134,014

(22) PCT Filed: Nov. 30, 2023
(86) PCT No.: PCT/US2023/081918

§ 371 Date: May 29, 2025

Related U.S. Application Data
(60) Provisional application No. 63/429,495, filed on Dec. 1, 2022.

(51) Int. Cl. G06Q 20/10; G06Q 20/06; G06Q 20/38

(52) U.S. Cl. CPC G06Q 20/10; G06Q 20/065; G06Q 20/389; G06Q 2220/00

(57) ABSTRACT

In systems and methods for efficient remittance, a server computer receives, from a first issuer computer via an application programming interface (API), a request to transfer an amount of first currency to a receiving party. The server computer obtains an amount of digital currency corresponding to the amount of first currency and records a record of the transfer to a ledger of interactions. The server computer causes the record to be recorded to a blockchain. The server computer transmits, to a second issuer computer, a notification of the transfer and receives, from the second issuer computer via the API, a request for an amount of second currency corresponding to the amount of digital currency. The server computer transmits the amount of the second currency to the second issuer computer, causing the second issuer computer to provide the amount of second currency to the receiving party.

### BACKGROUND

Remittances involve transferring a value from one party to another. While advances have been made in performing remittances electronically, remittance techniques are generally subject to inefficiencies and delays. For example, in traditional systems, multiple institutions operating within separate ecosystems are involved. In order to reconcile the transfer between the different parties, delays are common. Depending on the type of transfer and destination, remittances typically take between one and five days to settle.

Aspects of the present disclosure address these and other problems individually and collectively.

### BRIEF SUMMARY

The methods described herein provide a way to extend a user's ability to access to a resource securely and easily.

Embodiments include a method comprising: receiving, by a server computer from a first issuer computer via an application programming interface (API), a request to transfer an amount of a first currency to a receiving party; obtaining, by the server computer, an amount of digital currency corresponding to the amount of the first currency; recording, by the server computer, a record of the transfer of the amount of digital currency to a ledger of interactions, wherein the ledger of interactions includes a plurality of records for interactions in both the digital currency and the first currency; causing, by the server computer, a net amount for a plurality of records in the ledger including the record to be recorded to a blockchain corresponding to the digital currency; transmitting, by the server computer to a second issuer computer, a notification of the transfer; receiving, by the server computer from the second issuer computer via the API, a request for an amount of a second currency corresponding to the amount of the digital currency; and transmitting, by the server computer to the second issuer computer, via the API, a request to provide an amount of a second currency corresponding to the amount of digital currency to the receiving party, thereby causing the second issuer computer to provide the amount of the second currency to the receiving party.

In some aspects, the amount of the second currency is received by the receiving party less than ten seconds after the request to transfer the amount of the second currency is received.

In some aspects, the ledger of interactions comprises a plurality of subledgers, a subledger, of the plurality of subledgers, corresponding to the second issuer computer, and the server computer identifies a subledger, of the plurality of subledgers, corresponding to the second issuer computer and records the record to the subledger corresponding to the second issuer computer.

In some aspects, the method further includes identifying, by the server computer, a liquidity amount of the digital currency; and determining, by the server computer, that the liquidity amount exceeds a threshold, wherein the amount of the digital currency is obtained responsive to the determination.

In some aspects, the request is a first request, the amount of the first currency is a second amount, and the liquidity amount is a first liquidity amount, the method further comprising: receiving, by the server computer from the first issuer computer via the API, a second request to transfer a second amount of the first currency to a receiving party; identifying, by the server computer, a second liquidity amount of the digital currency; determining, by the server computer, that the second liquidity amount does not exceed the threshold; and responsive to determining that the second liquidity amount does not exceed the threshold, routing the second request for a fiat currency transfer.

In some aspects, obtaining the amount of the digital currency comprises converting the first currency to the digital currency via a remote computing device. In some aspects, obtaining the amount of the digital currency comprises minting the digital currency by the server computer. In some aspects, obtaining the amount of the digital currency comprises obtaining the amount of the digital currency from a liquidity pool held by the server computer.

In some aspects, the method further includes computing, by the server computer, the net amount for a plurality of records in the ledger including the record. In some aspects, the ledger stores interaction data for a plurality of interactions including transfers, purchases and sales.

In some embodiments, a computer-implemented method includes:

receiving, by a first issuer computer from a user device, a request to transfer an amount of a first currency to a receiving party; transmitting, by the first issuer computer to a server computer via an application programming interface (API), the request to transfer the amount, thereby causing the server computer to: record a record of the transfer of the amount of digital currency to a ledger of interactions, wherein the ledger of interactions includes a plurality of records for interactions in both the digital currency and the first currency; cause the amount of the digital currency to be recorded to a blockchain corresponding to the digital currency; and transmit, to a second issuer computer, the amount of digital currency, thereby causing the second issuer computer to provide the amount of a second currency to the receiving party.

In some aspects, the method further includes determining, by the first issuer computer, that an account associated with a user of a user of the user device has at least the amount requested, wherein the request is transmitted via the API to the server computer responsive to the determination.

Embodiments further include systems and computer-readable media for performing the above methods.

### BRIEF DESCRIPTION OF THE DRAWINGS

FIG. 1 shows an overview of a system for efficient remittance according to some embodiments.

FIG. 2 illustrates a communications flow diagram of operations performed by the system for efficient remittance according to some embodiments.

FIG. 3 illustrates a block diagram of the server computer of the system for efficient remittance according to some embodiments.

FIG. 4 illustrates a block diagram of the issuer computer of the system for efficient remittance according to some embodiments.

FIG. 5 illustrates a simplified flowchart illustrating a process for efficient remittance according to some embodiments.

FIG. 6 depicts examples illustrating ledger management according to some embodiments.

FIG. 7 depicts an example illustrating liquidity pooling according to some embodiments.

### DETAILED DESCRIPTION

Aspects of the present disclosure provide techniques for efficient remittance. As described above, in use cases such as sending money cross border from one currency to another, inefficiencies and delays are common due to the nature of traditional remittance and settlement techniques. The techniques described herein can provide substantially instantaneous settlement of funds, even cross-border and between currencies, using a central settlement ledger and digital currency blockchain to manage the transfer of funds.

In some examples, an amount is to be transferred to a receiving party. For example, a first amount of first currency (e.g., 500 US dollars) is to be transferred to the receiving party as a second amount of second currency (e.g., an equivalent amount in euros). A server computer manages remittances which can be requested via an application programming interface (API) exposed by the server computer. The server computer receives, from a first issuer computer via the API, a request to transfer an amount of first currency to a receiving party. The server computer obtains an amount of digital currency corresponding to the amount of first currency and records a record of the transfer to a ledger of interactions. The server computer causes the record to be recorded to a blockchain. The server computer transmits, to a second issuer computer, a notification of the transfer and receives, from the second issuer computer via the API, a request for an amount of second currency corresponding to the amount of digital currency. The server computer transmits the amount of the second currency to the second issuer computer, causing the second issuer computer to provide the amount of second currency to the receiving party.

Prior to discussing various embodiments, some terms can be described in further detail.

A “user” may include an individual. In some embodiments, a user may be associated with one or more personal accounts and/or user devices. The user may also be referred to as a cardholder, account holder, or consumer in some embodiments.

A “user device” may be any suitable device that may be operated by a user. User devices may include cellular phones, personal digital assistants (PDAs), pagers, tablets, personal computers, and the like. As additional examples, user devices may include wearable devices (e.g., watches, rings, etc.). A user device may comprise any suitable hardware and software for performing such functions, and may include multiple devices or components.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “blockchain” may refer to a distributed database. A blockchain can be used to maintain a continuously growing list of records called blocks. A blockchain can be used to maintain a record of transaction or events between parties in a way that is difficult to falsify. Each block in a blockchain may include several records as well as a hash of previous blocks in the blockchain. If a record in a previous block is changed, the hash may be disrupted in any following blocks. The result is that in order to falsify a given record, the hacker has to falsify that record and all subsequent records so that the hashes end up the same. This is extremely difficult in practice. Additionally, a blockchain may be distributed among a large number of entities. Any changes to the blockchain may be verified by comparing it to the numerous individual records.

A “record” may refer to evidence of one or more interactions. A digital record can be electronic documentation of an interaction. A record can include a record identifier and record information. For example, record information can include information describing one or more interactions and/or information associated with the interactions (e.g., a digital signature). Record information can also include multiple data packets each of which include different data describing a different interactions. A record identifier can be a number, title, or other data value used for identifying a record. A record identifier can be nondescript, in that it may not provide any meaningful information about the record information in the record. Examples of records include medical records, academic records, transaction records, credential issuance records, etc. In some embodiments, a record can be stored in a block of a blockchain. An individual block may include an individual record or a predetermined number of records, and a blockchain can be a series of records organized into blocks.

A “ledger” may be a digital object (e.g., a computer file, a database, a blockchain, and so forth) or physical object for recording transactions. Such transactions can include the exchange of specific resources, goods, services, financial instruments, access (e.g., to a secure resource or area), and so forth. Some ledgers may record and total economic transactions, measured in terms of a monetary unit, between various accounts. The ledger may be a permanent summary of all transactions and their amounts, along with the beginning and/or ending monetary balance for each account involved in the transaction.

An “issuer” may refer to an entity that maintains an account for a user. An issuer may provide or issue a credential to a user, and the credential can be used to access the account or a resource associated with the account. The account can be associated with a communication device such as an account enrolled in an application installed on a communication device. An issuer can also be associated with a host system that performs some or all of the functions of the issuer on behalf of the issuer. Examples of an issuer may include a service provider, a bank, a merchant, a governmental agency, a transaction processor, etc.

An “interaction” can be a reciprocal action, effect, or influence. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction may involve the exchange of monetary funds, or the exchange of goods or services for monetary funds between two individuals or entities.

The term “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

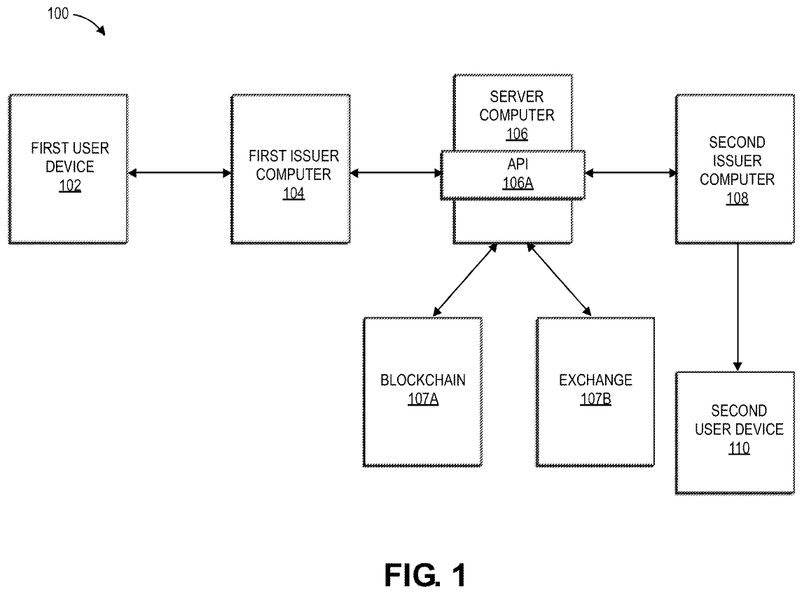

FIG. 1 shows an overview diagram of a system 100 for efficient remittance according to some embodiments. The system 100 includes one or more user devices (e.g., first user device 102 and second user device 110); one or more issuer computers (e.g., first issuer computer 104 and second issuer computer 108), and a server computer 106 coupled to a blockchain 107A and an exchange 107B.

Each of the user devices (e.g., first user device 102 and second user device 110) may be a device operable by a user and capable of executing applications. As examples, each of the first user device 102 and the second user device 110 may be a smartphone, a computer, a tablet, or the like.

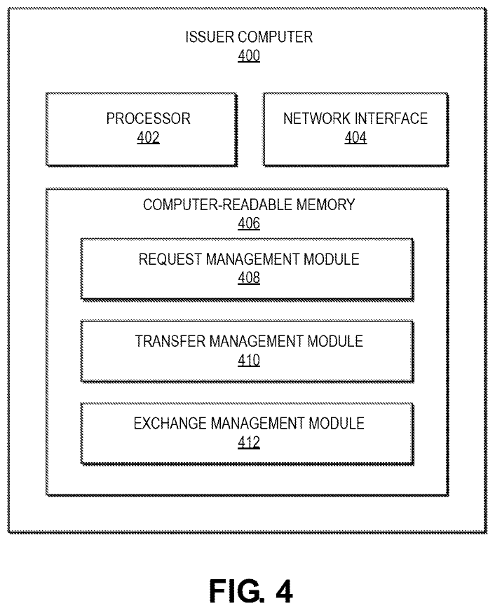

Each of the issuer computers (e.g., first issuer computer 104 and second issuer computer 108) may be computing devices operable by issuers. An example of an issuer computer is described in further detail below with respect to FIG. 4.

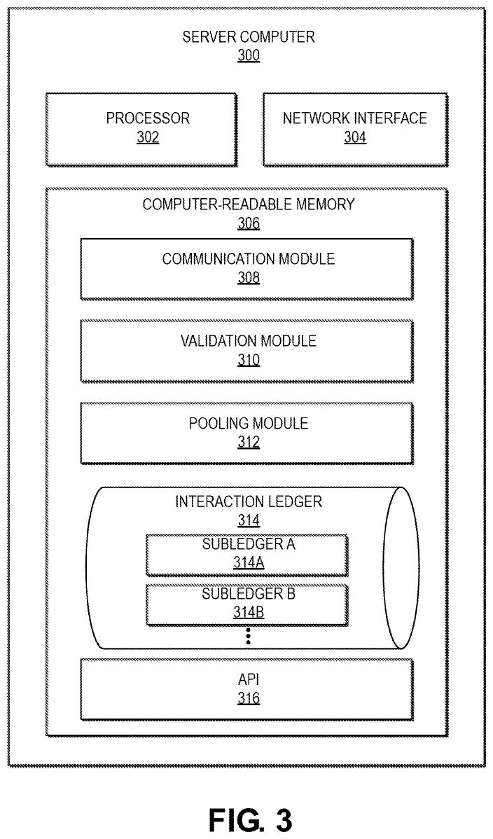

The server computer 106 may include functionality to manage remittances, as described herein. The server computer 106 includes one or more application programming interfaces (APIs), such as API 106A. An example of a server computer is described in further detail below with respect to FIG. 3.

The blockchain 107A is a blockchain ledger corresponding to a digital currency. The blockchain 107A may be managed by the server computer 106 or by a third party. In some examples, the blockchain 107A is a stablecoin blockchain such as the USD Coin (USDC) blockchain or the Tether (USDT) blockchain. (See, e.g., Hayes et al., “Stablecoins: Definition, How they Work, and Types,” Investopedia, available at https://www.investopedia.com/terms/s/stablecoin. asp (2022); Picardo et al., “USD Coin (USDC): Definition, How It Works in Currency, and Value,” Investopedia, available at https://www. investopedia.com/usd-coin-5210435 (2022)).

In some embodiments, a stablecoin such as USDC is implemented for remittance. A stablecoin is value-stable digital currency whose market price is backed by a low-volatility based stable asset. Stablecoins also differ from central bank digital currencies (CBDCs), which are digital representations of legal tender and direct liabilities of the central bank itself. In contrast to CBDCs, stablecoins are a private-market digital alternative to fiat currency in terms of a reliable medium of exchange. Stablecoin transactions can occur without a bank intermediary, enabling instantaneous settlement between transaction parties, regardless of geographic location. Stablecoin interactions are particularly desirable for the techniques described herein because they are permissioned, interoperable, trusted, stable and open loop.

In some examples, the exchange 107B is a currency exchange service. The exchange 107B may be managed by the server computer 106 or by a third party. In some examples, the exchange 107B is a digital payment network such as Visa Direct® (see, e.g., “Visa Direct,” Visa, available at https://usa.visa.com/run-your-business/visa-direct.html (2022)).

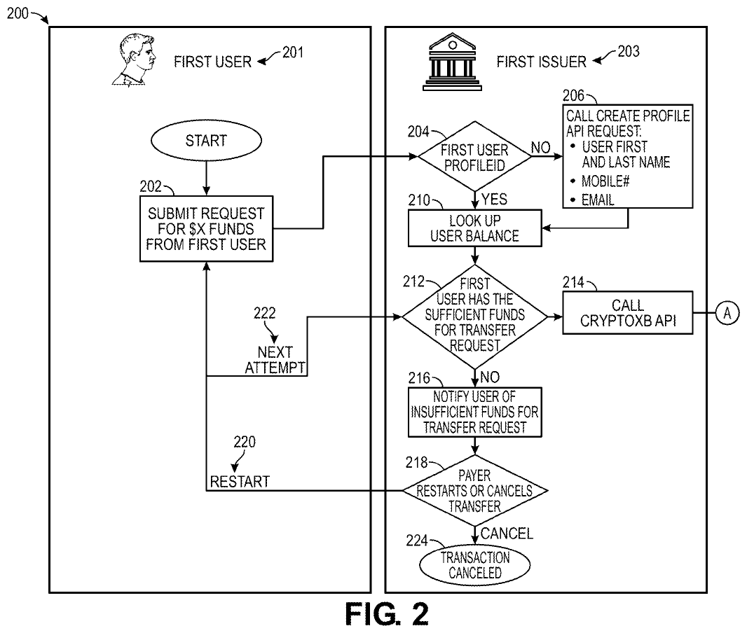

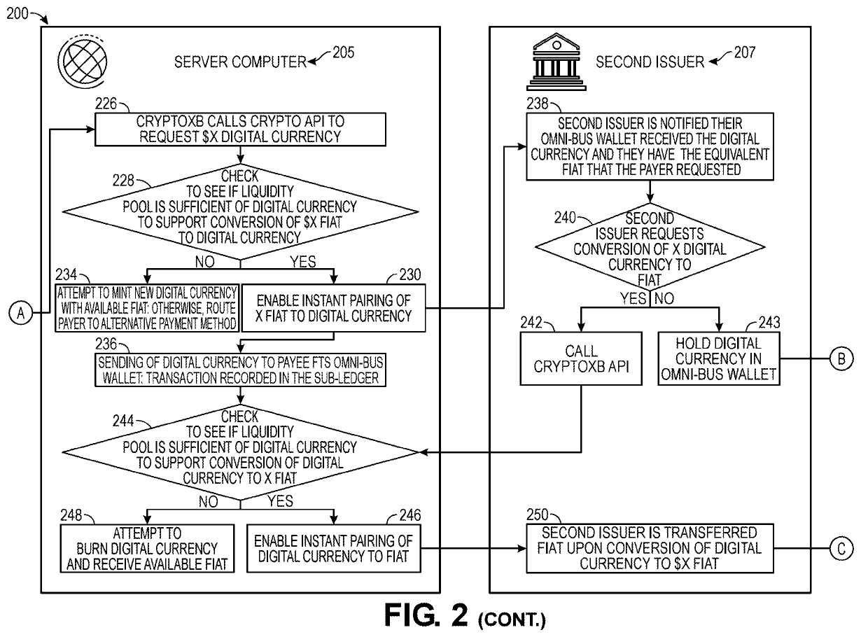

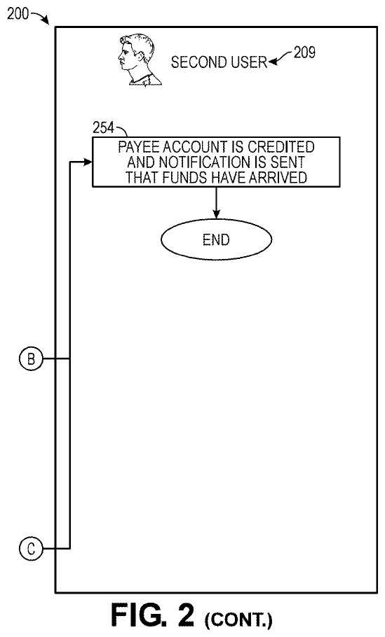

FIG. 2 shows a communications flow diagram of operations for efficient remittance according to some embodiments. In the example depicted in FIG. 2, the operations are performed by a first user 201 (e.g., associated with the first user device 102 of FIG. 1), a first issuer 203 (e.g., the associated with first issuer computer 104 of FIG. 1), a server computer 205 (e.g., the server computer 106 of FIG. 1), a second issuer 207 (e.g., associated with the second issuer computer 108 of FIG. 1), and a second user 209 (e.g., associated with the second user device 110 of FIG. 1).

At step 202, the first user 201 may submit a request for funds. For example, the first user 201 may transmit a transfer request to the first issuer 203 to transfer some amount of money in some currency, such as $X, to the second user 209. The request may, for example, be via an electronic transfer request sent from the first user device to the first issuer computer via a network. The first issuer 203 then receives the request.

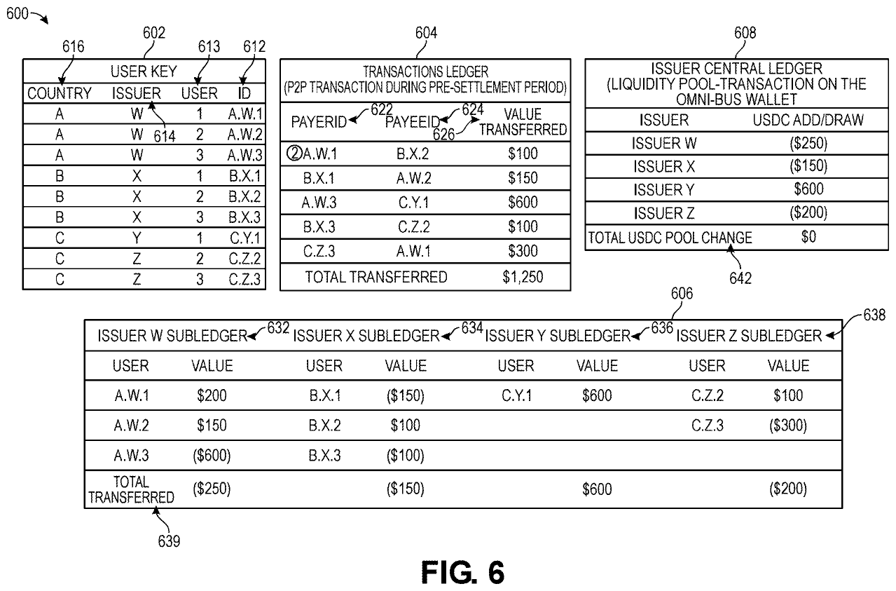

At step 204, the first issuer 203 determines whether the first user has a profile identifier established for an aliasing system. The aliasing system may be maintained by the server computer or a third party, and may map a user identifier to one or more accounts. The aliasing system may manage an alias directory that can be leveraged to identify the recipient without the need for account or bank identifiers. For example, the recipient can be identified based on name, phone number, email, etc. In some examples, the profile identifier links to a data store such as the user key table 602 depicted in FIG. 6.

At step 206, if the first user does not have an established profile at step 204, the first issuer 203 calls a create profile API request. The call profile API request can include one or more user identifiers such as a user first and last name. The call profile API request can alternatively or additionally include user contact information such as a mobile telephone number and/or email address. This call causes generation of a profile for the first user to manage interactions.

At step 210, if the first user does have an established profile at step 204, or subsequent to calling the create profile API request at step 206, the first issuer 203 looks up a user balance associated with the first user 201. The first issuer 203 may, for example, perform a database query using the identified first user profile identifier to retrieve user balance information.

At step 212, the first issuer 203 determines whether the first user has sufficient funds for the transfer request. The first issuer 203 may, for example, compare the user balance identified at step 210 to the transfer request amount received at 202. As another example, the first issuer 203 may compare the user balance identified at step 210 to another configured amount, such as the transfer request amount plus a threshold amount.

At step 214, if the first user has sufficient funds for the transfer request as determined by the first issuer 203 at step 212, then the first issuer 203 performs a call to the API exposed by the server computer 205 (e.g., “CryptoXB API” as shown in FIG. 2). The API call may request an amount (e.g., $X as originally requested at step 202) of digital currency. As described above with respect to FIG. 1, in some implementations, a stablecoin such as USDC is implemented, which is desirable for this application because it is permissioned, interoperable, trusted, stable and open loop. Since stablecoins are backed by fiat currency, there is not the risk of volatility associated with traditional cryptocurrencies such as bitcoin.

At step 216, if the first user does not have sufficient funds for the transfer request as determined by the first issuer 203 at step 212, the first issuer 203 notifies the user of insufficient funds for the transfer request. For example, the first issuer 203 transmits an alert to the user device of the first user 201 via a network communication. Based on such an alert, the first user 201 may restart the transfer at step 220 or cancel the transfer (e.g., by transmitting a response message to the first issuer computer over a network).

At step 218, the first issuer 203 determines whether the first user restarted or canceled the transfer. For example, the first issuer 203 parses a response received from the first user to identify whether the user has requested to restart or cancel the transaction.

At step 224, upon determining that the first user requested to cancel the transfer at step 218, the first issuer 203 cancels the transaction and the process ends.

At step 220, upon determining that the first user requested to restart the transfer at step 218, the first issuer 203 and the first user 201 restart the transaction. A next attempt is performed at step 222. The first issuer 203 once again determines whether the first user has sufficient funds at step 212. This may result in calling the API at step 214.

At step 226, the server computer 205 receives the request for digital currency via the API responsive to the API call transmitted at step 214.

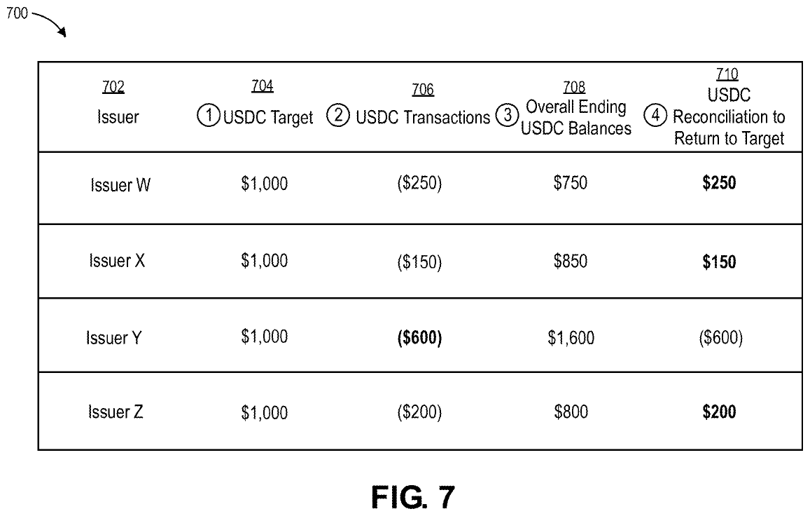

At step 228, the server computer 205 checks to determine whether a liquidity pool associated with the digital currency is sufficient to support conversion of the amount of fiat currency to digital currency. The server computer 205 may use one or more ledgers to manage a liquidity pool of digital and/or fiat currency across one or more issuers, as illustrated in the examples described below with respect to FIG. 6 and 7. The server computer can use the liquidity pool to quickly reallocate currency between institutions. For example, the server computer 205 identifies a liquidity amount of digital currency available by querying a ledger and compares this available amount to the fiat currency amount requested or that amount converted to the digital currency implemented. In the case of a US dollar backed stablecoin, the conversion is one-to-one and the server computer 205 determines whether the liquidity pool contains at least $X (or $X plus some threshold).

At step 230, if the server computer 205 determines that the liquidity pool is sufficient at step 228, the server computer 205 enables instant pairing of the amount of fiat currency to the equivalent amount of digital currency. If the amount is already in the liquidity pool, the server computer can adjust the records in the ledger to move the digital currency, instantly performing the transfer.

At step 234, if the server computer 205 determines that the liquidity pool is not sufficient at step 228, the server computer 205 attempts to mint new digital currency with the available fiat currency. The server computer 205 may use funds deducted from the first user's account balance to mint digital currency.

Alternatively, at step 234, if the server computer 205 determines that the liquidity pool is not sufficient at step 228, and the server computer 205 is unable to mint new digital currency with the available fiat currency, then the server computer routes the request to an alternative payment method, such as the exchange 107B depicted in FIG. 1. For example, a fiat currency transfer service can be used as fallback if digital currency is not available. As examples, a push payment or ACH transfer can be used as backup. This provides the benefit of avoiding dropped transactions due to digital currency liquidity issues, as without such a backup the transaction would be terminated.

At step 236, if the server computer 205 transmits the digital currency to a wallet associated with the second issuer 207 and the transaction is recorded in the subledger associated with the second issuer 207. In some aspects, the server computer 205 holds on behalf of each issuer an omnibus wallet. The omnibus wallet includes subledgers specifying funds allocated to each user (e.g., $ 50 belongs to user A, $100 belongs to user B, and so forth). Alternatively, or additionally, the server computer 205 manages a ledger with subledgers for different issuers. The ledger may include interactions in both fiat currency and digital currency. The server computer records the transaction to the subledger associated with the second issuer 207, which can be used to identify net settlement amounts across issuers, as described in further detail below with respect to the examples shown in FIG. 6 and FIG. 7.

The server computer 205 may consolidate the sub-ledgers daily through a net settlement process between issuers by using a blockchain (e.g., blockchain 107A of FIG. 1) to adjust balances. This adjustment of balances can be performed substantially instantly. By performing a net settlement on the blockchain periodically (e.g., daily) using a pooled amount, the server computer 205 can reduce interaction with the blockchain, reducing processing and network communications as well as fees.

At step 238, the second issuer 207 is notified of receipt of the digital currency. The second issuer 207 may then confirm that the second issuer 207 has the equivalent fiat currency amount requested by the first user 201 (e.g., a second currency corresponding to the location of the second user). For example, the user has requested to send X US dollars to the second user in euros. The second issuer 207 may determine an amount in euros equivalent to the amount of digital currency received and confirm that that amount of euros is held by the second issuer 207.

At step 240, the second issuer 207 determines whether to request conversion of the digital currency to fiat currency. For example, if the second issuer holds a sufficient amount of the second fiat currency, the second issuer may refrain from requesting conversion from the server.

At step 242, upon determining that the digital currency should be converted to fiat currency at step 240, the second issuer 207 calls the API exposed by the server computer 205.

At step 243, upon determining that the digital currency should not be converted to fiat currency at step 240, the second issuer 207 holds the digital currency in the omnibus wallet. The second issuer 207 may hold digital currency and payout the second user 209 with the reserves of local currency held by the second issuer 207.

At step 254, an account of the second user 209 is credited and notification is sent that the funds have arrived. The second user's account may be updated to reflect the amount transferred to the second user 209.

At step 244, the server computer 205 determines whether the liquidity pool associated with the digital currency is sufficient to support conversion of the amount of digital currency to fiat currency. For example, the server computer 205 identifies a liquidity amount of digital currency available in the liquidity pool and compares this available amount to the fiat currency amount requested.

At step 246, if the server computer 205 determines that the liquidity pool is sufficient at step 244, the server computer 205 enables instant pairing of the amount of digital currency to the equivalent amount of fiat currency. The server computer 205 may, for example, reallocate fiat currency (e.g., the second currency) and digital currency in the ledger to account for the exchange from to the amount of fiat currency.

At step 248, if the server computer 205 determines that the liquidity pool is not sufficient at step 244, the server computer 205 attempts to exchange digital currency for fiat currency (e.g., burn digital currency, which involves removing some amount of digital currency from circulation, and receive available fiat currency). The server computer 205 may transmit a request to an entity managing the digital currency to redeem the amount of the digital currency for an amount of fiat currency. In some implementations, the server computer 205 transmits the amount of the digital currency to the entity managing the digital currency. In some instances, the entity managing the digital currency then provides the amount of fiat currency to the server computer and deletes the amount of the digital currency from the blockchain record.

At step 250, the second issuer 207 is transferred fiat currency upon conversion of digital currency to fiat currency. The second issuer 207 may then credit the second user's account at step 254, as described above.

FIG. 3 illustrates a block diagram of a server computer 300, according to some embodiments. Server computer 300 may include a processor 302, a network interface 304, an interaction ledger 314, an API 316, and a computer readable memory 306 storing code executable by processor 302.

Processor 302 may be any suitable processing apparatus or device as described above. The processor 302 may be coupled to the network interface 304 and the computer readable memory 306.

The network interface 304 may include an interface that can allow the server computer 300 to communicate with external computers. The network interface 304 may enable the server computer 300 to communicate data to and from another device (e.g., the user devices, the issuer computers, etc.). Some examples of a network interface 304 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 304 may include Wi-Fi™. Data transferred via the network interface 304 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 304 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium. The network interface 304 can utilize a long-range communication channel and/or a short-range communication channel.

The computer readable memory 306 may be a non-transitory computer-readable medium that includes software code stored as a series of instructions or commands. Computer readable memory 306 may include a communication module 308, a validation module 310, a pooling module 312, and/or other suitable software modules. One or more these software modules may include code executable by processor 302 to perform functionalities including receiving, by a server computer from a first issuer computer via an application programming interface (API), a request to transfer an amount of a first currency to a receiving party; obtaining, by the server computer, an amount of digital currency corresponding to the amount of the first currency; recording, by the server computer, a record of the transfer of the amount of digital currency to a ledger of interactions, wherein the ledger of interactions includes a plurality of records for interactions in both the digital currency and the first currency; causing, by the server computer, a net amount for a plurality of records in the ledger including the record to be recorded to a blockchain corresponding to the digital currency; transmitting, by the server computer to a second issuer computer, a notification of the transfer; receiving, by the server computer from the second issuer computer via the API, a request for an amount of a second currency corresponding to the amount of the digital currency; and transmitting, by the server computer to the second issuer computer, via the API, a request to provide an amount of a second currency corresponding to the amount of digital currency to the receiving party, thereby causing the second issuer computer to provide the amount of the second currency to the receiving party.

Communication module 308 may provide functionality to generate and transmit network communications, which may be in the form of request and response messages, API calls, and so forth. In some aspects, communication module works in concert with an API 316 exposed by the server computer 300. For example, the server computer 300 exposes a CryptoXB API that facilitates cross-border digital currency (e.g., cryptocurrency) based transfers as described herein. The API 316 can receive requests from issuers (e.g., the first issuer, second issuer, and so forth) to transfer, generate, and/or convert digital currency.

Validation module 310 may provide functionality for validating information used for the remittance techniques described herein. For example, validation module 310 may determine the existence and status of accounts, amounts of funds held in fiat or digital currency, and so forth.

Pooling module 312 may provide functionality to manage pooling of digital and fiat currency across users and institutions. As described above with respect to FIG. 2, and below with respect to FIGS. 6 and 7, the server computer 300 can maintain liquidity pools of digital and fiat currency across issuers, which is used to perform net settlement of amounts on the blockchain.

Interaction ledger 314 is a ledger managed by the server computer 300 that tracks interactions. In some aspects, interaction ledger 314 includes a plurality of subledgers (e.g., subledger A 314A, subledger B 314B, and so forth, as depicted in FIG. 3). In some aspects, each subledger corresponds to a different issuer. For example, interactions involving a first issuer are recorded to subledger A 314A and interactions involving a second issuer are recorded to subledger 314B.

In some aspects, interaction ledger 314 is used to manage and consolidate balances in both fiat currency (e.g., a first currency such as dollars, and/or a second currency such as euros, etc.) and digital currency. The balances can be combined for both fiat currency balances and digital currency balances on a single ledger. Interaction ledger 314 may account for fiat currency balance statuses such as pending, available, settled, trading, and so forth, as well as transfers of digital currency assets. Interaction ledger 314 can account for payment, accounting, and trade of both digital currencies and fiat currencies across issuers on a single ledger.

FIG. 4 illustrates a block diagram of an issuer computer 400 (e.g., the first issuer computer 104 or the second issuer computer 108 shown in FIG. 1) according to some embodiments. Issuer computer 400 may include a processor 402, a network interface 404, and a computer readable memory 406 storing code executable by processor 402.

Processor 402 and network interface 404 may be similar to the processor 302 and network interface 304 described above with respect to FIG. 3.

Computer readable memory 406 may include a request management module 408, a transfer management module 410, an exchange management module 412, and/or other suitable software modules. One or more these software modules may include code executable by processor 402 to perform functionalities including receiving, from a user device, a request to transfer an amount of a first currency to a receiving party; transmitting, to a server computer via an application programming interface (API), the request to transfer the amount, thereby causing the server computer to: record a record of the transfer of the amount of digital currency to a ledger of interactions, wherein the ledger of interactions includes a plurality of records for interactions in both the digital currency and the first currency; cause the amount of the digital currency to be recorded to a blockchain corresponding to the digital currency; and transmit, to a second issuer computer, the amount of digital currency, thereby causing the second issuer computer to provide the amount of a second currency to the receiving party.

Request management module 408 may provide functionality to manage transfer requests. The request management module 408 may include functionality to receive and validate requests to transfer funds from one user to another.

Transfer management module 410 may provide functionality for validating and coordinating funds transfers. For example, transfer management module 410 may determine whether a user has sufficient funds for a transfer, and, if so, transmit a transfer request via API to the server computer 300.

Exchange management module 412 may provide functionality for currency exchange. Exchange management module 412 may itself exchange funds from fiat currency to digital currency or vice versa (e.g., via funds held by the issuer computer 400). Alternatively, or additionally, exchange management module 412 may manage an exchange by requesting server computer 300 to perform the exchange and transmitting and receiving the associated amounts of digital and fiat currency.

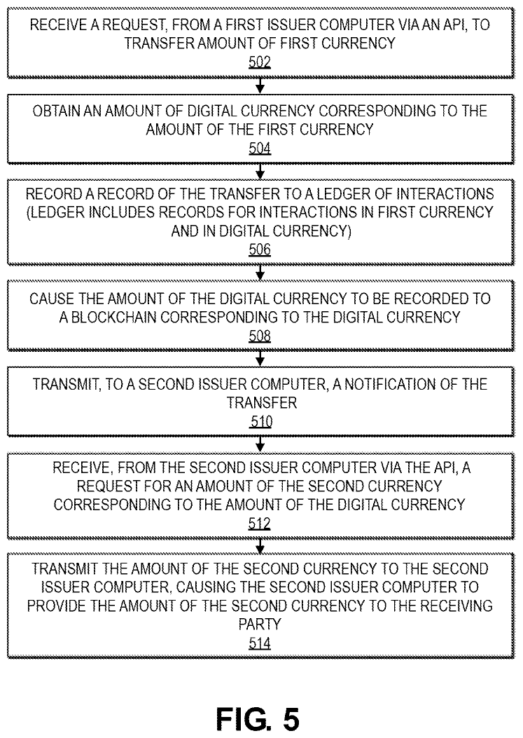

FIG. 5 illustrates a simplified flowchart illustrating a method 500 for efficient remittance according to some embodiments. The processing depicted in FIG. 5 may be implemented in software (e.g., code, instructions, program) executed by one or more processing units (e.g., processors, cores) of the respective systems, or combinations thereof. The method presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel. In some embodiments, the processing depicted in FIG. 5 may be performed by the server computer of FIGS. 1 and 3 and other components of the system 100 described above with respect to FIG. 1.

At step 502, the server computer receives a request to transfer an amount of a first currency. For example, the server computer receives a request from a first issuer computer, which may originate from a user request, as shown at steps 202-206 of FIG. 2. The request may include an identifier of a payer or first user from which the amount originates, an identifier of the first issuer from which the request is received, an amount of fiat currency associated with the first currency (e.g., dollars, pesos, rupiahs, etc.), an identifier a second issuer to receive the transfer, and/or an identifier of a second user to receive the transfer. The request may specify a first (payee) currency (e.g., dollars) and a second (recipient) currency (e.g., euros). As a specific example, a first user (payer) makes an order to his issuer bank to send $X in euro to his family in Spain. In some aspects, the request is received via an API exposed by the server computer, as described above.

In some embodiments, the server computer identifies a liquidity amount of the digital currency. For example, the server computer identifies a liquidity amount of digital currency available by querying a ledger and compares this available amount to the fiat currency amount requested or that amount converted to the digital currency implemented. If the liquidity amount exceeds a threshold, then the server computer may proceed to step 504. In some aspects, a threshold liquidity amount is configured.

At step 504, the server computer obtains an amount of digital currency corresponding to the amount of the first currency. Obtaining the amount of the digital currency may include obtaining the amount of the digital currency from a liquidity pool held by the server computer.

Alternatively, or additionally, the server computer obtains the amount of the digital currency by converting the first currency to the digital currency via a remote computing device. For example, the server computer obtains the digital currency from a digital currency exchange in exchange for an equivalent amount of fiat currency such as the amount of the first currency. The server computer may, alternatively or additionally, obtain the digital currency by minting the digital currency. Minting the digital currency may include generating the digital currency or causing the digital currency to be generated. For example, the server computer transmits an amount of fiat currency (e.g., the amount of first currency) to an account and requests an entity managing the digital currency to use a smart contract to create an equivalent amount of digital currency.

In some embodiments, if the liquidity amount of the digital currency is not sufficient, then the server computer may route the request to another channel, such as a push payment or Automated Clearing House (ACH) transfer. For example, the server computer may receive, from the first issuer computer via the API, a second request to transfer a second amount of the first currency to a receiving party. The server computer identifies a second liquidity amount of the digital currency and determines that the second liquidity amount does not exceed the threshold. Responsive to determining that the second liquidity amount does not exceed the threshold, the server computer routes the second request for a fiat currency transfer (e.g., using push payment, ACH transfer, or the like). As a specific example, a first request to transfer a first amount may be received and routed for digital currency-based transfer, and a second request to transfer a second amount may be received and routed for fiat currency-based transfer. For the first request, a first liquidity amount is above the threshold, and the digital currency is obtained at step 504. For the second request, a second liquidity amount is below the threshold, and the second request is routed for fiat currency transfer. This provides a backup channel to ensure that the transfer proceeds regardless of the digital currency liquidity status at a given time.

At step 506, the server computer records a record of the transfer to a ledger of interactions. The ledger includes records for interactions in the first currency and records for interactions in the digital currency, as described above with respect to FIG. 3. In some aspects, the ledger includes respective subledgers for respective issuers. The server computer may identify the subledger corresponding to the receiving issuer (e.g., the second issuer 207 of FIG. 2) and record the first record to the identified subledger. As described above with respect to step 236 of FIG. 2, in some aspects, the subledger corresponds to an omnibus wallet held by the receiving issuer. The ledger may store interaction data for a plurality of interactions including transfers, purchases and sales.

At step 508, the server computer causes the amount of the digital currency to be recorded to a blockchain corresponding to the digital currency. As described above with respect to FIG. 2, the server computer may use the ledgers and subledgers to identify a net amount of liquid digital currency across one or more issuers for a time period such as a day. The server computer may then perform a net settlement of this amount by recording an interaction for the net pooled amount to the blockchain on a periodic (e.g., daily) basis. In other words, the server computer may compute a net amount for a plurality of records in the ledger including the record, wherein the net amount is recorded to the blockchain.

In some examples, the server computer records the net amount to the blockchain by storing the data payload as a record in the current block of the blockchain. Alternatively, or additionally, the server computer causes the net amount to be recorded to the blockchain by another entity, e.g., by sending a request to an entity managing the blockchain. According to some embodiments, the blockchain can be organized into blocks, and each block may contain one or more records. Each block may include a block identifier that can be used to query the blockchain for a record.

The block identifier can be a sequential number, a random number, or a hash of the previous block of the blockchain, etc.

At step 510, the server computer transmits, to a second issuer computer, a notification of the transfer. The server computer may notify the second issuer computer that an omnibus wallet associated with the second issuer computer received the amount of the digital currency. The notification may, for example, be transmitted in a message over a network.

The second issuer computer may determine a reserve amount of the second currency held by the second issuer computer. If the amount of second currency available is at least equivalent to the amount of digital currency (or some other threshold amount), then the second issuer computer may hold the digital currency and use the amount of the second currency to provide to the second user. Otherwise, the second issuer computer calls the API exposed by the server computer to request the amount of the second currency corresponding to the amount of the digital currency, and the process proceeds to step 512.

At step 512, the server computer receives, from the second issuer computer via the API, a request for an amount of a second currency corresponding to the amount of the digital currency. The server computer may receive an API call from the second issuer computer, which may specify the amount of the second currency requested. Alternatively, or additionally, the API call may specify the amount of the digital currency and/or an identifier of the second user.

Responsive to receiving the request for the amount of the second currency at step 512, the server computer may check an amount of available digital currency in the liquidity pool, and either attempt to burn digital currency to receive the second currency or pair an amount of the digital currency held in the liquidity pool to the equivalent amount of the second currency, as described above with respect to steps 244-248 of FIG. 2.

At step 514, the server computer transmits, to the second issuer computer, the amount of the second currency corresponding to the amount of digital currency. For example, the server computer sends the amount of the second currency to the second issuer computer electronically via a network transmission. The server computer may send the amount of the second currency to the second issuer computer upon conversion of the digital currency to the second currency, responsive to the request received at step 512.

Transmitting the amount of the second currency to the second issuer computer causes the second issuer computer to provide the amount of the second currency to the receiving party. The receipt of the amount of the second currency and/or a notification thereof at step 514 may cause the second issuer computer to provide the amount of the second currency to the receiving party, e.g., by updating account information associated with receiving party.

As described above, the method 500 can provide instantaneous or near instantaneous movement of funds, even cross border and between different currencies. In some embodiments, the amount of the second currency is received by the receiving party less than ten seconds, less than five seconds, or less than one second after the request to transfer the amount of the second currency is received.

FIG. 6 illustrates examples of data structures 600 for ledger management according to some embodiments. The data structures include a user key table 602, a transaction ledger 604, issuer subledgers 606, and an issuer central ledger 608. While FIG. 7 shows the example of USDC as the digital currency, any suitable digital currency may be implemented.

The user key table 602 includes information associated with a set of users. For each user (e.g., a bank customer), a user identifier 612 is stored to a data store. The user identifier 612 may, for example, be a numeric identifier, the user's first and last name, or any other suitable identifier of the user. In some aspects, the user key table 602 includes multiple user identifiers 612, 613, such as a numerical identifier and a name. The user key table 602 maps, to a given user, an issuer identifier 614 such as a bank identifier and a country code 616. The information in the user key table 602 can be used to identify issuers associated with a particular user. The information in table 602 can also be used to identify an appropriate currency for a given user, based on the country code 616.

The transactions ledger 604 includes information associated with a set of transactions. In some instances, the transactions ledger 604 includes pre-settlement transactions. In the example shown in FIG. 6, the transactions ledger 604 includes a payer identifier 622, a payee identifier 624, and a value transferred 626. The transaction ledger 604 tracks a total value transferred between a set of users associated with different issuers. For example, user A.W. 1 from issuer W sends $100 to user B.X.2 at bank X, which is recorded on the transactions ledger 604 during the pre-settlement period.

The issuer subledgers 606 record transfers to subledgers for respective issuers. Issuer W subledger 632 records transfers to or from issuer W. Issuer X subledger 634 records transfers to or from issuer X. Issuer Y subledger 636 records transfers to or from issuer Y. Issuer Z subledger 638 records transfers to or from issuer Z. A total transferred 639 is also recorded for each respective issuer.

The issuer central ledger 608 records a digital currency liquidity needed in a liquidity pool for each of a set of issuers W, X, Y, and Z. The issuer central ledger 608 further records a total digital currency pool change 642. The example illustrated in FIG. 7 and described below further explains the digital currency liquidity pool.

FIG. 7 depicts an example 700 illustrating liquidity pooling according to some embodiments. In the example depicted in FIG. 7, digital currency liquidity is recorded for a set of issuers 702—issuer W, issuer X, issuer Y, and issuer Z. While FIG. 7 shows the example of USDC as the digital currency, any suitable digital currency may be implemented.

For each issuer 702, a respective USDC target 704 is recorded. Each issuer is allocated an agreed-upon starting balance of USDC, which determines an amount needed for the overall liquidity pool. In this example, each issuer 702 has a USDC target 704 of $1,000.

USDC transactions 706 are recorded over the course of an established time period, such as a day. As transactions occur, the respective USDC allocation for each issuer 702 changes depending on the transactions. For example, as shown in FIG. 7, issuer W has a transaction of—$250, issuer Y has a transaction of +$600, and so forth.

Overall ending USDC balances 708 are computed for the established time period. For example, for a given day, the USDC transactions 706 are added to or subtracted from the USDC target 704 for a given issuer 702. For example, at the end of the day, USDC balances are finalized based on the transactions across all users associated with a given issuer.

USDC reconciliation to return to target 710 tracks an amount to be reallocated between issuers 702 on the ledger in order to bring all issuers 702 back to their respective target USDC allocations 704. The server computer depicted in FIGS. 1 and 3 may mint additional USDC or remove USDC from the pool through conversion to fiat currency in order to maintain the USDC targets 704.

Embodiments of the invention provide several advantages. Compared with traditional remittance techniques that can take several hours or even several days, using the techniques described herein, the funds can be transferred from one user to another in seconds or even instantly. The system does not generally require traditional intermediary parties used for fiat currency transfers, which reduces the amount of network transmissions and processing required. By using digital currency as a transfer medium between the sending and receipt of fiat currency, cross-border remittances can be processed instantly or in a matter of seconds. On the other hand, traditional cross-border bank transfers require the involvement of multiple payment systems, partner banks, and regulatory processes that make the traditional remittance process take several days. Using a stablecoin as the digital currency medium provides the added benefits of stability, reliability, and seamless conversion (e.g., from US dollars to USDC or euro to Euro Coin). Thus, the techniques described herein can provide significantly faster results with reduced computational resource usage, compared to traditional remittance techniques.

Moreover, by pooling transactions before settling positions on the blockchain and between issuers, there are fewer network transmissions and messages to process the transfers, providing additional computational and time savings. The reduction in blockchain and issuer interactions also reduces fees, making for a more desirable user experience.

Further benefits are gained from the use of specialized APIs. The server computer exposes an API (e.g., a crypto API) to each issuer computer, which can be used to quickly and securely transfer data between the computing devices. Using a specialized crypto API, the issuer and server computers can efficiently push and pull data over a secure channel without the need for additional validation transmissions.

Additional advantages are provided by the ability to use existing digital currency, mint new digital currency, or route to alternative payment methods such as ACH transfer, as appropriate. This way, the most efficient method can be implemented without failed transactions, as would be the case without a backup in place.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

1. A computer-implemented method comprising:
receiving, by a server computer from a first issuer computer via an application programming interface (API), a request to transfer an amount of a first currency to a receiving party;
obtaining, by the server computer, an amount of digital currency corresponding to the amount of the first currency;
recording, by the server computer, a record of the transfer of the amount of digital currency to a ledger of interactions, wherein the ledger of interactions includes a plurality of records for interactions in both the digital currency and the first currency;
causing, by the server computer, a net amount for a plurality of records in the ledger including the record to be recorded to a blockchain corresponding to the digital currency;
transmitting, by the server computer to a second issuer computer, a notification of the transfer;
receiving, by the server computer from the second issuer computer via the API, a request for an amount of a second currency corresponding to the amount of the digital currency; and
transmitting, by the server computer to the second issuer computer, the amount of a second currency corresponding to the amount of digital currency,
thereby causing the second issuer computer to provide the amount of the second currency to the receiving party.

2. The method of claim 1, wherein the amount of the second currency is received by the receiving party less than ten seconds after the request to transfer the amount of the second currency is received.

3. The method of claim 1, wherein:
the ledger of interactions comprises a plurality of subledgers, a subledger, of the plurality of subledgers, corresponding to the second issuer computer, and
the server computer identifies a subledger, of the plurality of subledgers, corresponding to the second issuer computer and records the record to the subledger corresponding to the second issuer computer.

4. The method of claim 1, further comprising:
identifying, by the server computer, a liquidity amount of the digital currency; and
determining, by the server computer, that the liquidity amount exceeds a threshold, wherein the amount of the digital currency is obtained responsive to the determination.

5. The method of claim 4, wherein the request is a first request, the amount of the first currency is a second amount, and the liquidity amount is a first liquidity amount, the method further comprising:
receiving, by the server computer from the first issuer computer via the API, a second request to transfer a second amount of the first currency to a receiving party;
identifying, by the server computer, a second liquidity amount of the digital currency;
determining, by the server computer, that the second liquidity amount does not exceed the threshold; and
responsive to determining that the second liquidity amount does not exceed the threshold, routing the second request for a fiat currency transfer.

6. The method of claim 1, wherein obtaining the amount of the digital currency comprises converting the first currency to the digital currency via a remote computing device.

7. The method of claim 1, wherein obtaining the amount of the digital currency comprises minting the digital currency by the server computer.

8. The method of claim 1, further comprising:
computing, by the server computer, the net amount for a plurality of records in the ledger including the record.

9. The method of claim 1, wherein the ledger stores interaction data for a plurality of interactions including transfers, purchases and sales.

10. A server computer comprising:
a processor; and
a computer readable medium, operatively coupled to the processor, for performing a method comprising:
receiving, by a server computer from a first issuer computer via an application programming interface (API), a request to transfer an amount of a first currency to a receiving party;
obtaining an amount of digital currency corresponding to the amount of the first currency;
recording a record of the transfer of the amount of digital currency to a ledger of interactions, wherein the ledger of interactions includes a plurality of records for interactions in both the digital currency and the first currency;
causing the amount of the digital currency to be recorded to a blockchain corresponding to the digital currency;
transmitting, by the server computer to a second issuer computer, a notification of the transfer;
receiving, by the server computer from the second issuer computer via the API, a request for an amount of a second currency corresponding to the amount of digital currency; and
transmitting, by the server computer to the second issuer computer, the amount of digital currency,
thereby causing the second issuer computer to provide the amount of the second currency to the receiving party.

11. The server computer of claim 10, wherein the amount of the second currency is received by the receiving party less than ten seconds after the request to transfer the amount of the second currency is received.

12. The server computer of claim 10, wherein:
the ledger of interactions comprises a plurality of subledgers, a subledger, of the plurality of subledgers, corresponding to the second issuer computer, and
the server computer identifies a subledger, of the plurality of subledgers, corresponding to the second issuer computer and records the record to the subledger corresponding to the second issuer computer.

13. The server computer of claim 10, the method further comprising:
identifying a liquidity amount of the digital currency; and
determining that the liquidity amount exceeds a threshold, wherein the amount of the digital currency is obtained responsive to the determination.

14. The server computer of claim 13, wherein the request is a first request, the amount of the first currency is a second amount, and the liquidity amount is a first liquidity amount, the method further comprising:
receiving, by the server computer from the first issuer computer via the API, a second request to transfer a second amount of the first currency to a receiving party;
identifying, by the server computer, a second liquidity amount of the digital currency;
determining, by the server computer, that the second liquidity amount does not exceed the threshold; and
responsive to determining that the second liquidity amount does not exceed the threshold, routing the second request for a fiat currency transfer.

15. The server computer of claim 10, wherein obtaining the amount of the digital currency comprises one of:
obtaining the amount of the digital currency from a liquidity pool held by the server computer;
converting the first currency to the digital currency via a remote computing device; or
minting the digital currency by the server computer.

16. The server computer of claim 10, the method further comprising:
computing a net amount for a plurality of records in the ledger including the record, wherein the net amount is recorded to the blockchain.

17. The server computer of claim 10, wherein the ledger stores interaction data for a plurality of interactions including transfers, purchases and sales.

18. A computer-implemented method comprising:
receiving, by a first issuer computer from a user device, a request to transfer an amount of a first currency to a receiving party;
transmitting, by the first issuer computer to a server computer via an application programming interface (API), the request to transfer the amount, thereby causing the server computer to:
record a record of the transfer of the amount of digital currency to a ledger of interactions, wherein the ledger of interactions includes a plurality of records for interactions in both the digital currency and the first currency;
cause the amount of the digital currency to be recorded to a blockchain corresponding to the digital currency; and
transmit, to a second issuer computer, the amount of digital currency, thereby causing the second issuer computer to provide the amount of a second currency to the receiving party.

19. The method of claim 18, further comprising:
determining, by the first issuer computer, that an account associated with a user of a user of the user device has at least the amount requested, wherein the request is transmitted via the API to the server computer responsive to the determination.

20. The method of claim 18, wherein the amount of the second currency is received by the receiving party less than ten seconds after the request to transfer the amount of the second currency is received.

21.-22. (canceled)
